(19) United States
(12) Patent Application Publication
(10) Pub. No.: US 2020/0259437 A1
(43) Pub. Date: Aug. 13, 2020

(54) MOTOR CONTROL METHOD, MOTOR CONTROL SYSTEM, AND ELECTRIC POWER STEERING SYSTEM

(71) Applicant: Nidec Corporation, Kyoto (JP)

(72) Inventor: Ahmad GHADERI, Kyoto (JP)

(21) Appl. No.: 16/487,861

(22) PCT Filed: Feb. 19, 2018
(86) PCT No.: PCT/JP2018/005800

§ 371 Date: Aug. 22, 2019

(30) Foreign Application Priority Data
Mar. 23, 2017 (JP) 2017-057564

(51) Int. Cl. H02P 21/22; H02P 27/08; H02P 21/18; B62D 5/04

(52) U.S. Cl. CPC H02P 21/22; H02P 27/08; H02M 7/53871; B62D 5/0409; B62D 5/046; H02P 21/18

(57) ABSTRACT

A method of controlling a motor includes obtaining a component BEMF_{α} on an α-axis and a component BEMF_{β} on a β-axis of counter electromotive force of the motor, performing time differentiation on each of the component BEMF_{α} and the component BEMF_{β}, squaring a differentiated value of the component BEMF_{α} to obtain a first multiplication value and squaring a differentiated value of the component BEMF_{β} to obtain a second multiplication value, calculating a square root of a sum of the first multiplication value and the second multiplication value, obtaining an absolute value of the counter electromotive force based on the component BEMF_{α} and the component BEMF_{β}, obtaining at least one of a rotational speed and a number of revolutions of a rotor based on the absolute value of the counter electromotive force and a value of the square root, and controlling the motor based on at least one of the rotational speed and the number of revolutions of the rotor.

### CROSS REFERENCE TO RELATED APPLICATIONS

This is the U.S. national stage of application No. PCT/JP2018/005800, filed on Feb. 19, 2018, and priority under 35 U.S.C. § 119(a) and 35 U.S.C. § 365(b) is claimed from Japanese Application No. 2017-057564, filed Mar. 23, 2017; the entire contents of which are incorporated herein by reference.

### 1. FIELD OF THE INVENTION

The present disclosure relates to a motor control method, a motor control system, and an electric power steering system.

### 2. BACKGROUND

In a control system of an electric motor (hereinafter expressed as a “motor”), information such as a position (a rotor angle) and a rotational speed of a rotor of a motor is required in addition to information on motor current and voltage. For example, the rotor angle and the rotational speed are obtained on the basis of detected values by position sensors such as Hall sensors or resolvers. The rotational speed may be calculated on the basis of a time variation of the rotor angle.

Conventionally, a related art discloses methods of detecting a steering angular velocity (a velocity corresponding to a rotational speed of a motor) used in a steering system. In these methods, an anisotropic magnetoresistive element is used as a steering angle sensor (a sensor corresponding to a position sensor) to detect the steering angular velocity. Specifically, a steering angle signal is generated on the basis of an output signal from the steering angle sensor, and the steering angular velocity is detected on the basis of a time variation of the steering angle signal. For example, in the method according to the related art, the steering angular velocity is calculated by dividing a steering angle variation by a required time, which is from a time when the steering angle changes to a time when the steering angle changes next, corresponding the steering angle variation.

### SUMMARY

The above-described related art may also be used as a method of calculating a rotational speed of a motor. For example, the rotational speed of a rotor may be calculated on the basis of a time variation of a rotor angle detected by a position sensor. When the position sensor in a motor control system is damaged by, for example, some impact from the outside, it is impossible to calculate the rotational speed of the rotor on the basis of an output of the sensor. Meanwhile, techniques for estimating the rotor angle and the rotational speed using an observer instead of the position sensor are known. However, since such an estimation generally requires more complicated calculations, computational loads on a computer may be increased.

According to an example embodiment of the present disclosure, a method of controlling a motor includes a step A of obtaining a component BEMF_{α} on an α-axis and a component BEMF_{β} on a β-axis of a counter electromotive force of the motor in an αβ fixed coordinate system, a step B of performing time differentiation on each of the component BEMF on the α-axis and the component BEMF_{β} on the β-axis, a step C of squaring a differentiated value of the component BEMF_{α} on the α-axis to obtain a first multiplication value and squaring a differentiated value of the component BEMF_{β} on the β-axis to obtain a second multiplication value, a step D of calculating a square root of a sum of the first multiplication value and the second multiplication value, a step E of obtaining an absolute value of the counter electromotive force in the αβ fixed coordinate system based on the component BEMF_{α} on the α-axis and the component BEMF_{β} on the β-axis, a step F of obtaining at least one of a rotational speed and a number of revolutions of a rotor of the motor based on the absolute value of the counter electromotive force and a value of the square root, and a step G of controlling the motor based on at least one of the rotational speed and the number of revolutions of the rotor.

According to another example embodiment of the present disclosure, a motor control system includes a motor and a control circuit to control the motor to obtain a component BEMF_{α} on an α-axis and a component BEMF_{β} on a β-axis of a counter electromotive force of the motor in an αβ fixed coordinate system, perform time differentiation on each of the component BEMF_{α} on the α-axis and the component BEMF_{β} on the R-axis, square a differentiated value of the component BEMF_{α} on the α-axis to obtain a first multiplication value and square a differentiated value of the component BEMF_{β} on the β-axis to obtain a second multiplication value, calculate a square root of a sum of the first multiplication value and the second multiplication value, obtain an absolute value of the counter electromotive force in the αβ fixed coordinate system based on the component BEMF_{α} on the α-axis and the component BEMF_{β} on the β-axis, obtain at least one of a rotational speed and a number of revolutions of a rotor of the motor based on the absolute value of the counter electromotive force and a value of the square root, and control the motor based on at least one of the rotational speed and the number of revolutions of the rotor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram Illustrating a hardware block of a motor control system 1000 according to a first example embodiment of the present disclosure.

FIG. 2 is a block diagram illustrating a hardware configuration of an inverter 300 of the motor control system 1000 according to the first example embodiment of the present disclosure.

FIG. 3 is a block diagram illustrating a hardware block of a motor control system 1000 according to a modified example of the first example embodiment of the present disclosure.

FIG. 4 is a functional block diagram illustrating a functional block of a controller 100.

FIG. 5 is a functional block diagram illustrating functional blocks of a rotation number calculation unit 110.

FIG. 6 is a graph illustrating a waveform of an actual number of revolutions within a predetermined period when a motor is rotating at high speed in a forward rotation direction.

FIG. 7 is a graph illustrating a waveform of a rotor angle within the predetermined period.

FIG. 8 is a graph illustrating a waveform of counter electromotive force BEMF_{α} (top), a waveform of counter electromotive force BEMFβ (middle), and a waveform of a counter electromotive force magnitude Vm (bottom) within the predetermined period.

FIG. 9 is a graph illustrating a waveform of the estimated number of revolutions within the predetermined period when the motor is rotating at high speed in the forward rotation direction.

FIG. 10 is a graph illustrating a waveform of an actual number of revolutions within a predetermined period when the motor is rotating at high speed in a reverse rotation direction.

FIG. 11 is a graph illustrating a waveform of a rotor angle within the predetermined period.

FIG. 12 is a graph illustrating a waveform of counter electromotive force BEMF_{α} (top), a waveform of counter electromotive force BEMF_{β} (middle), and a waveform of a counter electromotive force magnitude Vm (bottom) within the predetermined period.

FIG. 13 is a graph illustrating a waveform of the estimated number of revolutions within the predetermined period when the motor is rotating at high speed in the reverse rotation direction.

FIG. 14 is a graph illustrating a waveform of an actual number of revolutions within a predetermined period when a motor is rotating at low speed in a forward rotation direction.

FIG. 15 is a graph illustrating a waveform of a rotor angle within the predetermined period.

FIG. 16 is a graph illustrating a waveform of counter electromotive force BEMF_{α} (top), a waveform of counter electromotive force BEMF_{β} (middle), and a waveform of a counter electromotive force magnitude Vm (bottom) within the predetermined period.

FIG. 17 is a graph illustrating a waveform of the estimated number of revolutions within the predetermined period when the motor is rotating at low speed in the forward rotation direction.

FIG. 18 is a graph illustrating a waveform of an actual number of revolutions within a predetermined period when the motor is rotating at low speed in a reverse rotation direction.

FIG. 19 is a graph illustrating a waveform of a rotor angle within the predetermined period.

FIG. 20 is a graph illustrating a waveform of counter electromotive force BEMF_{α} (top), a waveform of counter electromotive force BEMF_{β} (middle), and a waveform of a counter electromotive force magnitude Vm (bottom) within the predetermined period.

FIG. 21 is a graph illustrating a waveform of the estimated number of revolutions within the predetermined period when the motor is rotating at low speed in the reverse rotation direction.

FIG. 22 is a schematic view illustrating a typical configuration of an electric power steering (EPS) system 2000 according to a second example embodiment of the present disclosure.

### DETAILED DESCRIPTION

Hereinafter, example embodiments of a motor control method, a motor control system, and an electric power steering system having the motor control system of the present disclosure will be described in detail with reference to the accompanying drawings. However, in order to avoid unnecessary redundancy in the following description and to facilitate the understanding of those skilled in the art, the unnecessary detailed description may be omitted. For example, the detailed description of already well-known matters and redundant description of substantially the same configuration may be omitted.

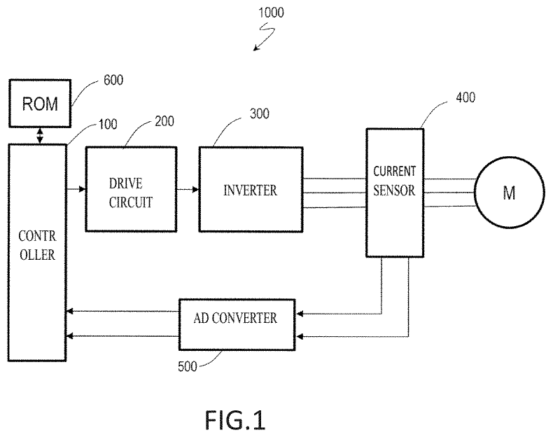

FIG. 1 schematically illustrates a hardware block of a motor control system 1000 according to the present example embodiment.

The motor control system 1000 typically includes a motor M, a controller (a control circuit) 100, a driving circuit 200, an inverter (also referred to as an “inverter circuit”) 300, a plurality of current sensors 400, and an analog-to-digital conversion circuit (hereinafter, expressed as an “AD converter”) 500, and a read only memory (ROM) 600. The motor control system 1000 may be modularized, and manufactured as a motor module including, for example, a motor, a sensor, a driver, and a controller, and sold. In the present specification, the motor control system 1000 will be described as an example of a system including the motor M as a component. However, the motor control system 1000 may be a system for driving the motor M without including the motor M as a component.

The motor M is, for example, a permanent magnet synchronous motor such as a surface-mounted permanent magnet synchronous motor (SPMSM) or an interior permanent magnet synchronous motor (IPMSM), and a three-phase alternating current (AC) motor. For example, the motor M includes three-phase (U-phase, V-phase, and W-phase) windings (not shown). The three-phase windings are electrically connected to the inverter 300. The present disclosure is not limited to the three-phase motor, but a multi-phase motor such as a five-phase motor and a seven-phase motor is within the scope of the present disclosure. In the present specification, example embodiments of the present disclosure will be described with a motor control system that controls a three-phase motor as an example.

The controller 100 is, for example, a micro control unit (MCU). The controller 100 may also be implemented by, for example, a field-programmable gate array (FPGA) in which a central processing unit (CPU) core is incorporated.

The controller 100 controls the entire motor control system 1000, for example, controls the torque and rotational speed of the motor M through vector control. The motor M may be controlled not only by the vector control but also by another closed loop control. The rotational speed corresponds to an angular velocity of a rotor and is represented by an angle (rad/s) at which the rotor rotates in one second. Further, the rotational speed may be represented by the number of revolutions (revolution per minute (RPM)) at which the rotor rotates in unit time (for example, one minute) or the number of revolutions (revolutions per second (RPS)) at which the rotor rotates in one unit time (for example, one second). In the present specification, the rotational speed and the number of revolutions may be used interchangeably without distinction.

The vector control is a method of decomposing a current flowing into a motor into a current component involved to the generation of torque and a current component involved to the generation of magnetic flux, and independently controlling each current component orthogonal to each other. The controller 100 sets a target current value according to, for example, an actual current value measured by the plurality of current sensors 400 and a rotor angle estimated on the basis of the actual current value. The controller 100 generates a pulse width modulation (PWM) signal on the basis of the target current value and outputs the generated PWM signal to the driving circuit 200.

The controller 100 may calculate the number of revolutions of the rotor on the basis of the actual current values measured by the plurality of current sensors 400. The controller 100 controls the motor M on the basis of the calculated number of revolutions.

The driving circuit 200 is typically a gate driver. The driving circuit 200 generates a control signal for controlling switching operations of switching elements in the inverter 300 according to the PWM signal output from the controller 100. As described later, the driving circuit 200 may be mounted in the controller 100.

The inverter 300 converts, for example, direct current (DC) power supplied from a DC power supply (not shown) into AC power, and drives the motor M using the converted AC power. For example, the inverter 300 may convert the DC power into three-phase AC power, which is a pseudo sine wave of a U-phase, a V-phase, and a W-phase, on the basis of the control signal output from the driving circuit 200. The motor M is driven by the converted three-phase AC power.

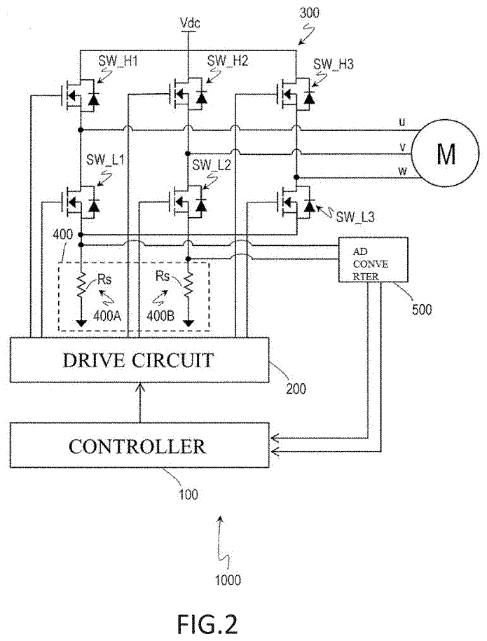

The plurality of current sensors 400 include at least two current sensors which detect at least two currents flowing through U-phase, V-phase, and W-phase windings of the motor M. In the present example embodiment, the plurality of current sensors 400 include two current sensors 400A and 400B (see FIG. 2) which detect the currents flowing through the U-phase and the V-phase windings. Of course, the plurality of current sensors 400 may include three current sensors which detect three currents flowing through the U-phase, V-phase, and W-phase windings, and may include two current sensors which detect the currents flowing through, for example, the V-phase and W-phase windings, or the W-phase and U-phase windings. Each current sensor includes, for example, a shunt resistor, and a current detection circuit (not shown) which detects a current flowing through the shunt resistor. A resistance value of the shunt resistor is, for example, about 0.1Ω.

The AD converter 500 samples analog signals output from the plurality of current sensors 400, converts the sampled analog signals into digital signals and outputs the converted digital signals to the controller 100. The controller 100 may perform an AD conversion. In that case, the plurality of current sensors 400 may directly output the analog signals to the controller 100.

The ROM 600 is, for example, a writable memory (for example, a programmable ROM (PROM)), a rewritable memory (for example, a flash memory), or a read only memory. The ROM 600 stores a control program including an instruction group allowing the controller 100 to control the motor M. For example, the control programs are once loaded in a random access memory (RAM) (not shown) at booting. The ROM 600 is not required to be externally attached to the controller 100 and may be mounted in the controller 100. The controller 100 mounted with the ROM 600 may be, for example, the above-described MCU.

A hardware configuration of the inverter 300 will be described in detail with reference to FIG. 2.

FIG. 2 schematically illustrates the hardware configuration of the inverter 300 of the motor control system 1000 according to the present example embodiment.

The inverter 300 includes three low-side switching elements SW_L1, SW_L2, and SW_L3 and three high-side switch elements SW_H1, SW_H2, and SW_H3. As the switching element, for example, a semiconductor switching element such as a field effect transistor (FET) (typically a metal oxide semiconductor FET (MOSFET)) or an insulated gate bipolar transistor (IGBT) may be used. The switching element includes a freewheeling diode.

FIG. 2 illustrates shunt resistors Rs of two current sensors 400A and 400B which detect the currents flowing through the U-phase and V-phase windings. As illustrated in the drawing, for example, the shunt resistor Rs may be electrically connected between the low-side switching element and the ground. Alternatively, for example, the shunt resistor Rs may be electrically connected between the high-side switching element and the power supply.

The controller 100 may drive the motor M by performing a three-phase energization control using, for example, vector control. For example, the controller 100 generates a PWM signal for performing the three-phase energization control and outputs the generated PWM signal to the driving circuit 200. The driving circuit 200 generates a gate control signal for controlling the switching operation of each switching element (for example, MOSFET) of the inverter 300 on the basis of the PWM signal, and inputs the generated gate control signal to a gate of each switching element.

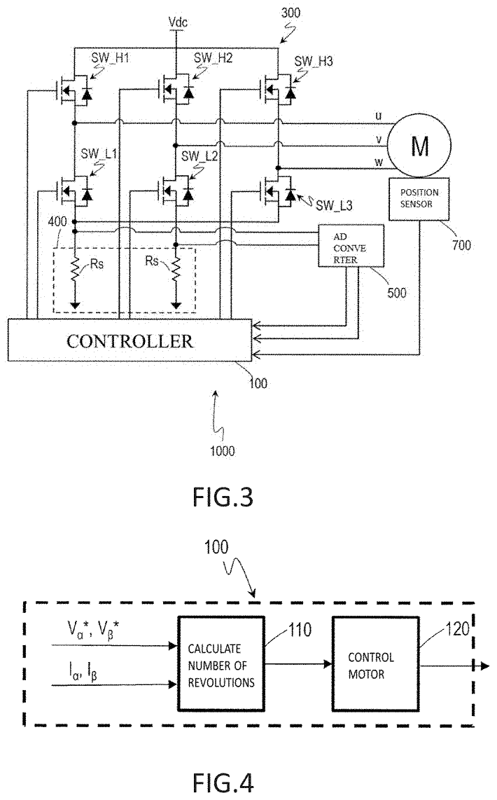

FIG. 3 schematically illustrates a hardware block of a motor control system 1000 according to a modified example of the present example embodiment.

As illustrated in the drawing, the motor control system 1000 may not include a driving circuit 200. In that case, a controller 100 includes ports that directly control a switching operation of each switching element of an inverter 300. Specifically, the controller 100 may generate a gate control signal on the basis of a PWM signal. The controller 100 may output the gate control signal through the port and may input the gate control signal to a gate of each switching element.

As shown in FIG. 3, the motor control system 1000 may further include a position sensor 700. The position sensor 700 is disposed in the vicinity of a motor M and detects a rotor angle. Specifically, the position sensor 700 detects a mechanical angle of the rotor and outputs the detected mechanical angle to the controller 100. The position sensor 700 is implemented through a combination of a magnetoresistance (MR) sensor having an MR element, and a sensor magnet. Further, the position sensor 700 may be, for example, a resolver or a Hall integrated circuit (IC).

The motor control system 1000 may include, for example, a speed sensor or an acceleration sensor instead of the position sensor 700. When the speed sensor is used as the position sensor, the controller 100 may perform an integration processing or the like on a rotational speed signal or an angular velocity signal to calculate the rotor angle. Further, when the acceleration sensor is used as the position sensor, the controller 100 may perform an integration processing or the like on an angular acceleration signal to calculate the rotor angle.

The motor control system of the present disclosure may be used in, for example, a motor control system for performing so-called sensorless control without including a position sensor as shown in FIGS. 1 and 2. The motor control system of the present disclosure may also be used in, for example, a motor control system including a position sensor as shown in FIG. 3.

Hereinafter, a specific example of a control method of the motor control system 1000 will be described as an example of motor control by sensorless control with reference to FIGS. 4 and 5, and a method of estimating the number of revolutions of a rotor will be mainly described. The motor control method of the present disclosure may be used in various motor control systems in which the estimation of the number of revolutions is required.

For example, the motor control method according to the present example embodiment, in particular, an algorithm for realizing the estimation of the number of revolutions of the rotor may be realized only by hardware such as an application specific integrated circuit (ASIC) or an FPGA, or may be implemented by a combination of hardware and software.

FIG. 4 schematically illustrates functional blocks of the controller 100. FIG. 5 schematically illustrates functional blocks of a rotation number calculation unit 110 of the controller 100. In the present specification, each block in the functional block diagram is shown as a functional block unit rather than a hardware unit. Software may be a module constituting computer programs, for example, for executing specific processing corresponding to each functional block.

As shown in FIG. 4, the controller 100 includes, for example, the rotation number calculation unit 110 and a motor control unit 120. In the present specification, each functional block is expressed as a “unit” for the convenience of explanation. Of course, the expression is not used with the intention of being interpreted as limiting each functional block to the hardware or the software.

The rotation number calculation unit 110 estimates at least one of the rotational speed and the number of revolutions of the rotor on the basis of reference voltages V_{α} * and V_{β}* and currents (armature current) I_{α} and I_{β}. The motor control unit 120 controls the motor M on the basis of at least one of the rotational speed and the number of revolutions of the rotor estimated by the rotation number calculation unit 110.

The rotation number calculation unit 110 includes, for example, a counter electromotive force calculation unit 111, two time differentiation units 112_1, and 112_2, four square units 113_1, 113_2, 113_3, and 113_4, two adders 114_1 and 114_2, two square root units 115_1 and 115_2, a divider 116, and a rotation number computing unit 117.

When each functional block is implemented as software and mounted in the controller 100, the executing subject of the software may be, for example, a core of the controller 100. As described above, the controller 100 may be realized by an FPGA. In that case, all or some of the functional blocks may be realized in hardware. Further, computational loads of a specific computer may be distributed by distributing processing using a plurality of FPGAs. In that case, all or some of the functional blocks shown in FIG. 4 or FIG. 5 may be distributed, and mounted in the plurality of FPGAs. The plurality of FPGAs are connected to communicate with each other by, for example, a control area network (CAN) mounted in a vehicle and may transmit and receive data.

For example, in a three-phase energization control, in consideration of the direction of the current, the sum of the currents flowing through the three-phase windings is “0” for each electrical angle in a general Y-connection motor. In other words, the relationship in which the sum of currents Iₐ, I_{b}, and I_{c} becomes zero is satisfied. The current flowing through the U-phase winding of the motor M is expressed as Iₐ, the current flowing through the V-phase winding of the motor M is expressed as I_{b}, and the current flowing through the W-phase winding of the motor M is expressed as I_{c}.

The controller 100 (for example, core) receives two currents of the currents Iₐ, I_{b}, and I_{c} and calculates to obtain a remaining one current. In the present example embodiment, the controller 100 obtains the current Iₐ measured by a current sensor 400A and the current I_{b} measured by a current sensor 400B. The controller 100 calculates the current I_{c} on the basis of the currents Iₐ and I_{b} using the above-described relationship in which the sum of the currents Iₐ, I_{b}, and I_{c} is zero. The currents Iₐ, I_{b}, and I_{c} measured using three current sensors may be input to the controller 100.

The controller 100 may transform the currents Iₐ, I_{b}, and I_{c} into currents I_{α} and I_{β} on α- and β-axes of an αβ fixed coordinate system using so-called Clarke transformation used in vector control or the like. Here, the αβ fixed coordinate system is a stationary coordinate system. A direction of one of the three phases (for example, U-phase direction) is the α-axis, and a direction orthogonal to the α-axis is the β-axis.

The controller 100 transforms reference voltages Vₐ*, V_{b}*, and V_{c}* into reference voltages V_{α} * and V_{β}* on the α- and β-axes of the αβ fixed coordinate system further using the Clarke transformation. The reference voltages Vₐ*, V_{b}*, and V_{c}* represent the above-described PWM signals for controlling each switching element of the inverter 300.

For example, calculations for determining the currents I_{α} and I_{β} and the reference voltages V_{α} * and V_{β}* may also be performed by the motor control unit 120 of the controller 100. In that case, the currents I_{α} and I_{β} and the reference voltages V_{α} * and V_{β}* may be input to the rotation number calculation unit 110.

The counter electromotive force calculation unit 111 calculates a counter electromotive force component BEMF_{α} on the α-axis and a counter electromotive force component BEMF_{β} on the β-axis by the following Equations (1) and (2) on the basis of the currents I_{α} and I_{β} and the reference voltages V_{α} * and V_{β}*. Thus, the counter electromotive force components BEMF_{α} and BEMF_{β} are obtained.

BEMF_{α}=V_{α}*−R·I_{α} Equation (1)

BEMF_{β}=V_{β}*−R·I_{β} Equation (2)

wherein, R is armature resistance. The armature resistance R is set in the counter electromotive force calculation unit 111 by, for example, the core of the controller 100.

The counter electromotive force components BEMF_{α} and BEMF_{β} calculated by Equations (1) and (2) are originally expressed using fundamental waves and harmonics. Here, generally, the counter electromotive force components BEMF_{α} and BEMF_{β} are filtered for the purpose of removing the harmonics using, for example, a general-purpose low-pass filter included in the controller 100. By such filtering, the counter electromotive force components BEMF_{α} and BEMF_{β} may be represented only by the fundamental waves as shown in the following Equations (3) and (4),

BEMF_{α}=Vm·cos(ρ) Equation (3)

BEMF_{β}=Vm·sin(ρ) Equation (4)

Vm=(BEMF_{α}²+BEMF_{β}²)^{1/2} Equation (5)

wherein, Vm (sometimes expressed as “back electromotive force (BEMF)”) is a counter electromotive force magnitude (absolute value) and represented by Equation (5). Further, ρ is a phase angle and expressed as a function of time t represented by, for example, the following Equation (6), and ω represents a rotational speed, and ρ (0) represents an initial phase.

ρ(t)=ω·t+ρ(0) Equation (6).

In the present specification, the initial phase is zero. In that case, the counter electromotive force components BEMF_{α} and BEMF_{β} may be represented by the following Equations (7) and (8).

BEMF_{α}=Vm·cos(w·t) Equation (7).

BEMF_{β}=Vm·sin(w·t) Equation (8).

The counter electromotive force calculation unit 111 outputs the counter electromotive force component BEMF_{α} to the time differentiation unit 112_1 and the square unit 113_3. The counter electromotive force calculation unit 111 outputs the counter electromotive force component BEMF_{β} to the time differentiation unit 112_2 and the square unit 113_4.

The time differentiation computing unit 112_1 performs time differentiation on the counter electromotive force component BEMF, represented by Equation (7). Equation (9) may be obtained by performing time differentiation on the BEMF_{α} of Equation (7) Here, “′” represents an operator of the time differentiation.

BEMF_{α}′=−ω·Vm·sin(w·t) Equation (9).

The time differentiation computing unit 112_2 performs time differentiation on the counter electromotive force component BEMF_{β} represented by Equation (8). Equation (10) may be obtained by performing time differentiation on the BEMF_{β} of Equation (8).

BEMF_{β}′=ω·Vm·cos(ω·t) Equation (10).

The square unit 113_1 squares the time differentiated value BEMF_{α}′ of the counter electromotive force component BEMF_{α} to obtain a first multiplication value. The first multiplication value is represented by Equation (11). The square unit 113_2 squares the time differentiated value BEMF_{β}′ of the counter electromotive force component BEMF_{β} to obtain a second multiplication value. The second multiplication value is represented by Equation (12). The adder 114_1 adds the first multiplication value and the second multiplication value.

(BEMF_{α}′)²=ω²·Vm²·sin²(ω·t) Equation (11).

(BEMF_{β}′)²=ω²·Vm²·cos²(ω·t) Equation (12).

The square root unit 115_1 calculates the square root of the added value of the adder 114_1. The value of the square root is represented by Equation (13).

[(BEMF_{α}′)²+(BEMF_{β}′)²]^{1/2}=ω·Vm Equation (13).

The square unit 113_3 squares the counter electromotive force component BEMF_{α}. The squared value is represented by Equation (14). The square unit 113_4 squares the counter electromotive force component BEMF_{β}. The squared value is represented by Equation (15).

(BEMF_{α})²=Vm²·cos²(ω·t) Equation (14).

(BEMF_{β})²=Vm²·sin²(ω·t) Equation (15).

The adder 114_2 adds the value obtained by squaring the counter electromotive force component BEMF_{α} and the value obtained by squaring the counter electromotive force component BEMF_{β}. The square root unit 115_2 calculates the square root of the added value of the adder 114_2. The square rooted value is represented by Equation (16). The absolute value of the counter electromotive force in the αβ fixed coordinate system is obtained on the basis of the counter electromotive force component BEMF_{α} and the counter electromotive force component BEMF_{β}.

(BEMF_{α}²+BEMF_{β}²)^{1/2}=Vm Equation (16).

The rotation number calculation unit 110 may obtain at least one of the rotational speed and the number of revolutions of the rotor of the motor M on the basis of the square rooted value of the square root unit 115_1 and the absolute value of the counter electromotive force.

The divider 116 divides the output of the square root unit 115_1 by the output (the absolute value of the counter electromotive force) of the square root unit 115_2. The divided value refers to the rotational speed shown in Equation (17).

ω·Vm/Vm=ω Equation (17)

The rotation number computing unit 117 calculates the number of revolutions f (rps) of the rotor from the rotational speed w output from the divider 116. The relationship between the rotational speed w and the number of revolutions f is as shown in Equation (18).

f=ω/2π Equation (18)

The rotation number calculation unit 110 may estimate at least one of the rotational speed and the number of revolutions on the basis of the motor current and output the rotational speed and the number of revolutions to the motor control unit 120. For example, the rotation number computing unit 117 is not absolutely necessary when information on the number of revolutions is not required in the motor control system. The information on the rotational speed and the number of revolutions is also used, for example, for various filtering processes in vector control.

The motor control unit 120 controls the motor on the basis of at least one of the rotational speed and the number of revolutions estimated by the rotation number calculation unit 110. For example, the motor control unit 120 may control the motor M through the sensorless control using the number of revolutions. The motor control unit 120 performs, for example, calculations required for general vector control. Also, since the vector control is a well-known technique, a detailed description of the vector control is omitted.

According to the present example embodiment, the rotational speed and the number of revolutions of the rotor may be estimated on the basis of the motor current. Thus, the sensorless control which does not use a position sensor may be used, and thus a failure of the position sensor and an increase in system cost due to the addition of hardware may be suppressed. Further, the calculations for estimating the rotational speed and the number of revolutions of the rotor may be simplified, thereby reducing memory costs.

When a position sensor is damaged due to, for example, some external impact in a motor control (expressed as “sensor control”) system which uses a position sensor, it is impossible to obtain the rotational speed of the rotor on the basis of the output of the position sensor. Meanwhile, when the position sensor has failed, it is possible to switch the motor control from the sensor control to the sensorless control. The motor may be continuously controlled even when the position sensor fails by applying the estimation method of the number of revolutions of the rotor according to the present disclosure to the sensorless control.

The following is the result of verifying the validity of the algorithm used for estimating the number of revolutions of the rotor according to the present disclosure using dSPACE's “rapid control prototyping (RCP) system” and MathWorks Matlab/Simulink. A model of a surface permanent magnetic (SPM) motor controlled by vector control was used for the verification. Table 1 shows values of various system parameters during the verification.

TABLE 1

| Moment of inertia | 6.9e⁻⁵ | [kg · m²] |
|---|---|---|
| Friction coefficient | 5.1e⁻³ | [Nm/(rad/s)] |
| Resistance (motor + ECU) | 8.50 mΩ + 5.43 mΩ | |
| L_{d} (nominal) | 40.7 | μH |
| L_{q} (nominal) | 38.8 | μH |
| Voltage range | 10~16 | V |
| Temperature range | −40° C.~90° C. | |
| Motor type | Brushless DC motor | |
| Pole number | 8 | |
| Slot number | 12 | |
| Maximum current | 77 | A |
| Rated voltage | 13.5 | V |
| Rated temperature | 80° | C. |
| Maximum torque | 5.96 | N · m |
| Diameter of winding | ϕ 1.45 | mm |

| | |
|---|---|
| Number of turns | 11.5 |

Rotational directions of the rotor generally have a forward rotation direction and a reverse rotation direction. In the present specification, when viewed from a load side, a direction in which the rotor rotates in a counterclockwise direction around an axis of a shaft is referred to as the “forward rotation direction”, and a direction in which the rotor rotates in a clockwise direction around the axis of the shaft is referred to as the “reverse rotation direction”. Of course, the forward and reverse rotation directions may be defined differently for each product specification.

First, simulation results obtained when the rotor is rotating at high speed in the forward rotation direction will be described. For example, when an electric power steering (EPS) system is assumed, ranges of the high speed for the rotation in the forward rotation direction may be, for example, 26.2 rps or more.

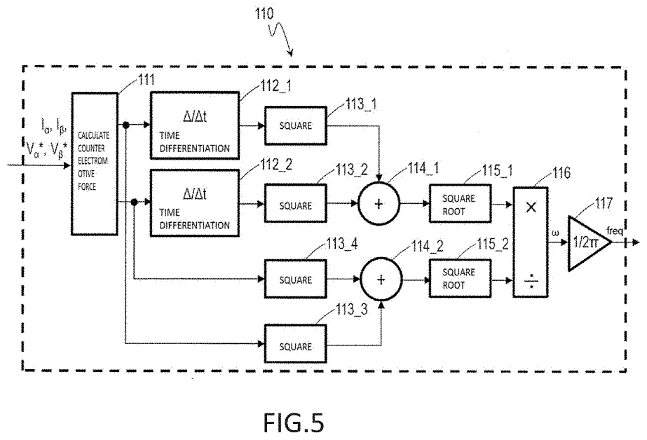

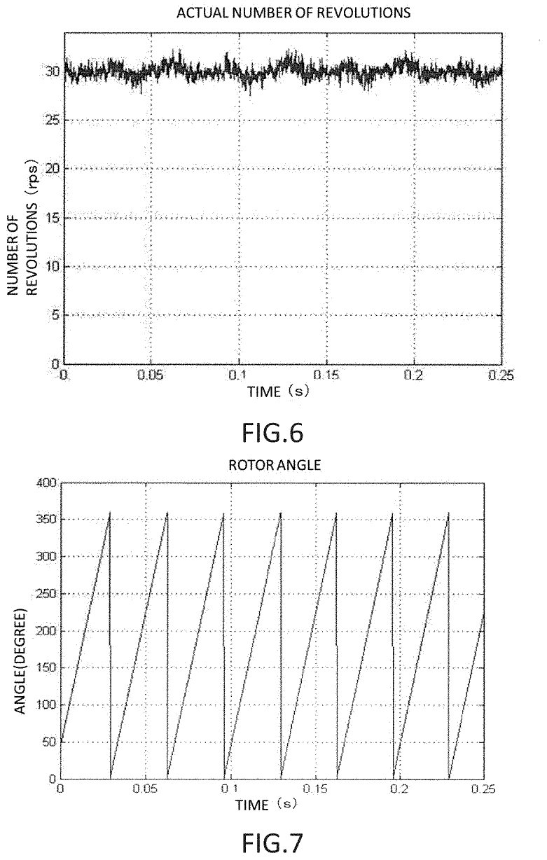

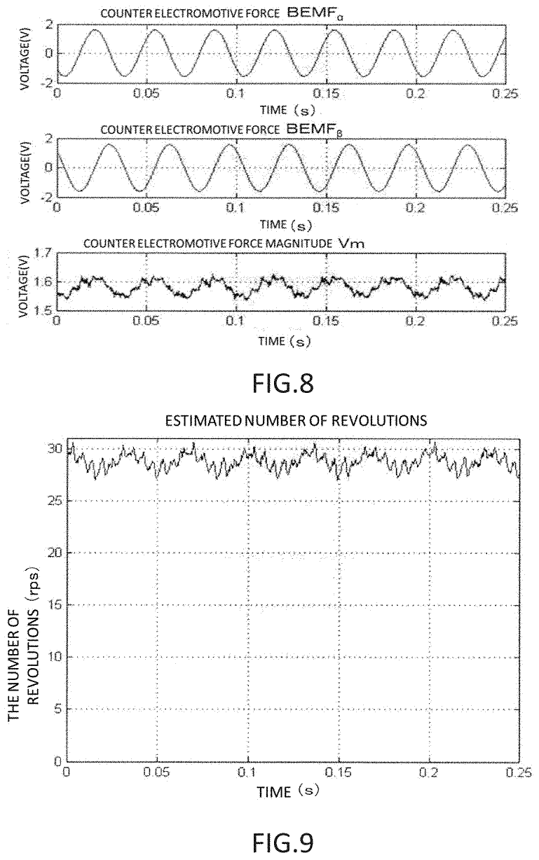

FIG. 6 illustrates a waveform of the actual number of revolutions (rps) of the motor within a predetermined period (0 to 0.25 seconds). FIG. 7 illustrates a waveform of rotor angles within the predetermined period. FIG. 8 illustrates a waveform of counter electromotive force BEMF_{α} (top), a waveform of counter electromotive force BEMF_{β} (middle), and a waveform of a counter electromotive force magnitude Vm (bottom) within the predetermined period. FIG. 9 illustrates a waveform of the number of revolutions (rps) of the motor within the predetermined period, which is estimated by the method of estimating the number of revolutions according to the present disclosure. Horizontal axes in FIGS. 6 to 9 represent time (seconds). Vertical axes in FIGS. 6 and 9 represent the number of revolutions (rps). The vertical axis in FIG. 7 represents the rotor angle (degree). The vertical axis in FIG. 8 represents a voltage (V).

FIGS. 6 to 9 illustrate various waveforms obtained when the rotor is rotating at high speed (30 rps) in the forward rotation direction.

The result of FIG. 9 means that the rotation number calculation unit 110 obtained the number of revolutions (−30 rps) of the rotor. Comparing FIGS. 6 and 9, it may be seen that when the rotor is rotating at high speed in the forward rotation direction, values close to the actual number of revolutions of the rotor may be accurately estimated. Further, noise is superimposed on the waveform of the actual number of revolutions shown in FIG. 6.

Next, simulation results obtained when the rotor is rotating at high speed in the reverse rotation direction will be described. For example, when the EPS system is assumed, ranges of the high speed for the rotation in the reverse rotation direction may be, for example, −26.2 rps or less.

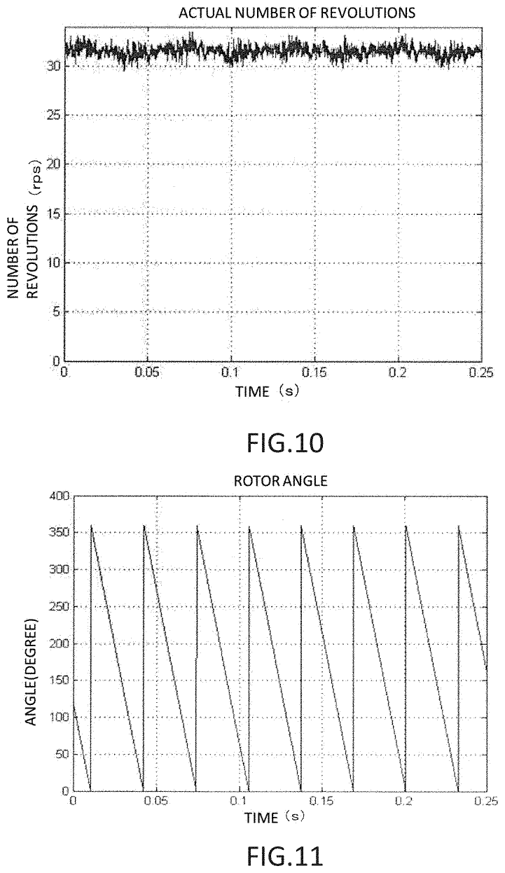

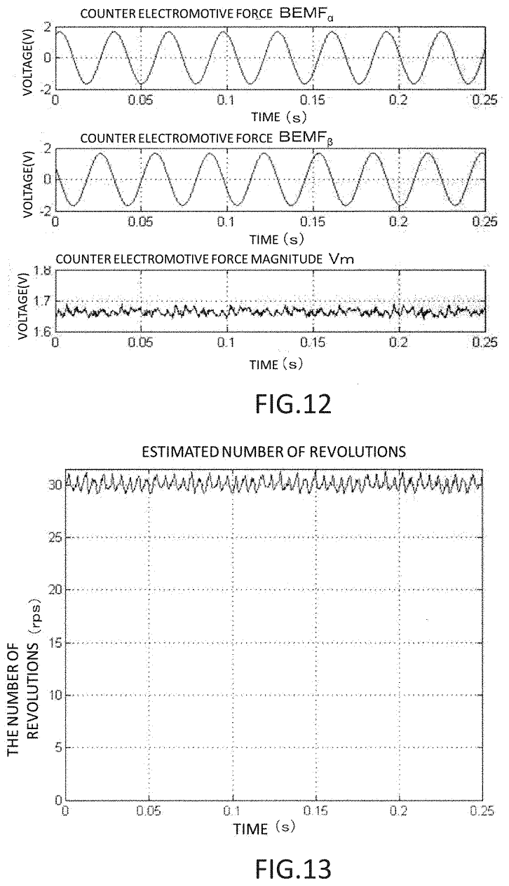

FIG. 10 illustrates a waveform of the actual number of revolutions (rps) of the motor within a predetermined period (0 to 0.25 seconds). FIG. 11 illustrates a waveform of rotor angles within the predetermined period. FIG. 12 illustrates a waveform of counter electromotive force BEMF_{α} (top), a waveform of counter electromotive force BEMF_{β} (middle), and a waveform of a counter electromotive force magnitude Vm (bottom) within the predetermined period. FIG. 13 illustrates a waveform of the number of revolutions (rps) of the motor within the predetermined period, which is estimated by the method of estimating the number of revolutions according to the present disclosure. Horizontal axes in FIGS. 10 to 13 represent time (seconds). Vertical axes in FIGS. 10 and 13 represent the number of revolutions (rps). The vertical axis in FIG. 11 represents the rotor angle (degree). The vertical axis in FIG. 12 represents a voltage (V).

FIGS. 10 to 13 illustrate various waveforms obtained when the rotor is rotating at high speed (−30 rps) in the reverse rotation direction. In FIGS. 10 and 13, absolute values of the number of revolutions of the motor are shown.

The result of FIG. 13 means that the rotation number calculation unit 110 obtained the number of revolutions (−30 rps) of the rotor. Comparing FIGS. 10 and 13, it may be seen that when the rotor is rotating at high speed in the reverse rotation direction, values close to the actual number of revolutions of the rotor may be accurately estimated.

Next, simulation results obtained when the rotor is rotating at low speed in the forward rotation direction will be described. For example, when the EPS system is assumed, ranges of the low speed for the rotation in the forward rotation direction may be, for example, more than 0.0 rps and less than 26.2 rps.

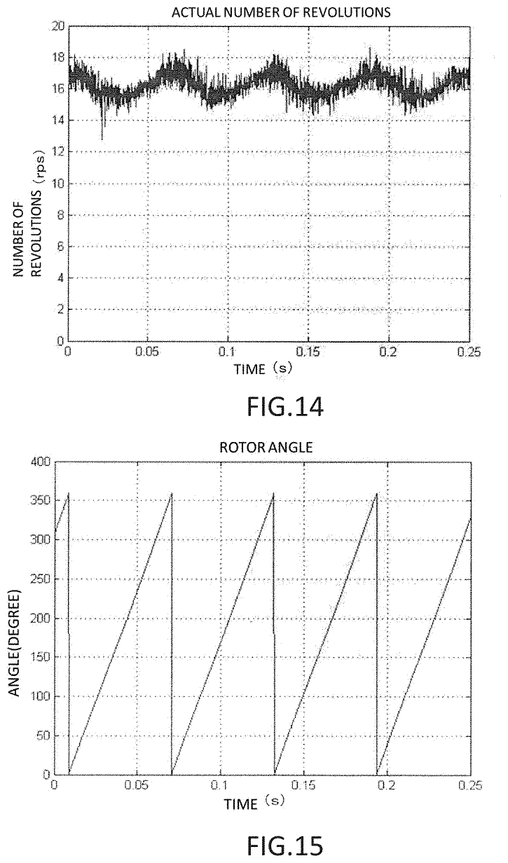

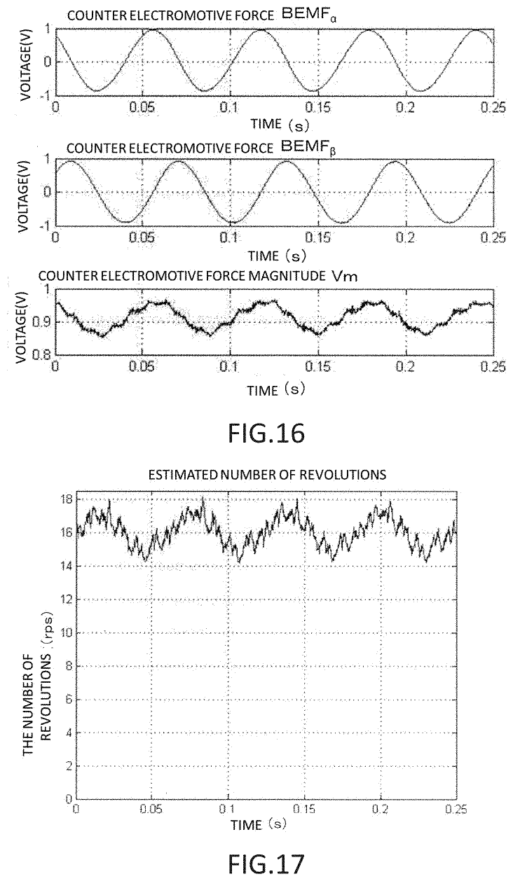

FIG. 14 illustrates a waveform of the actual number of revolutions (rps) of the motor within a predetermined period (0 to 0.25 seconds). FIG. 15 illustrates a waveform of rotor angles within the predetermined period. FIG. 16 illustrates a waveform of counter electromotive force BEMF_{α} (top), a waveform of counter electromotive force BEMF_{β} (middle), and a waveform of a counter electromotive force magnitude Vm (bottom) within the predetermined period FIG. 17 illustrates a waveform of the number of revolutions (rps) of the motor within the predetermined period, wherein the number of revolutions is estimated by the method of estimating the number of revolutions according to the present disclosure. Horizontal axes in FIGS. 14 to 17 represent time (seconds). Vertical axes in FIGS. 14 and 17 represent the number of revolutions (rps). The vertical axis in FIG. 15 represents the rotor angle (degree). The vertical axis in FIG. 16 represents a voltage (V).

FIGS. 14 to 17 illustrate various waveforms obtained when the rotor is rotating at low speed (16 rps) in the forward rotation direction.

The result of FIG. 17 means that the rotation number calculation unit 110 obtained the number of revolutions (16 rps) of the rotor. Comparing FIGS. 14 and 17, it may be seen that when the rotor is rotating at low speed in the forward rotation direction, values close to the actual number of revolutions of the rotor may be accurately estimated.

Finally, simulation results obtained when the rotor is rotating at low speed in the reverse rotation direction will be described. For example, when the EPS system is assumed, ranges of the low speed for the rotation in the reverse rotation direction may be, for example, more than −26.2 rps and less than 0.0 rps.

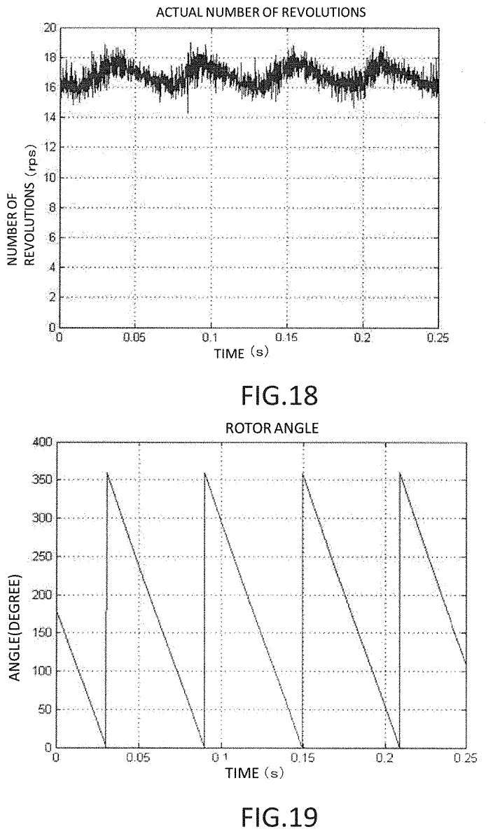

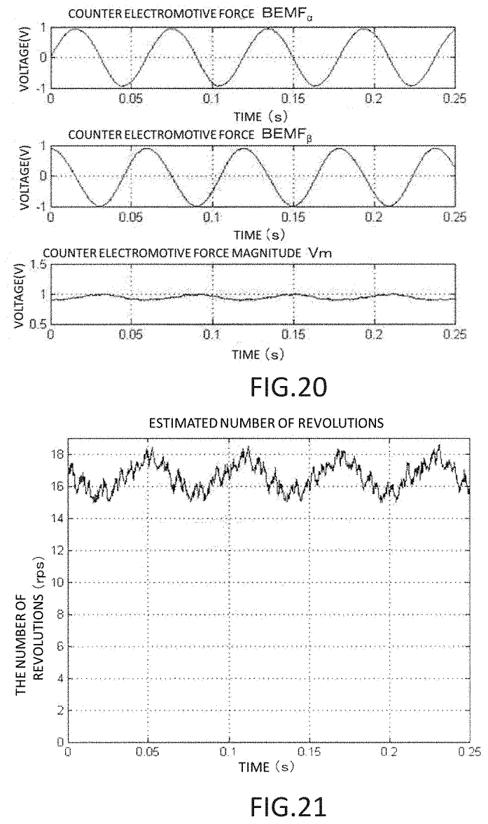

FIG. 18 illustrates a waveform of the actual number of revolutions (rps) of the motor within a predetermined period (0 to 0.25 seconds). FIG. 19 illustrates a waveform of rotor angles within the predetermined period. FIG. 20 illustrates a waveform of counter electromotive force BEMF_{α} (top), a waveform of counter electromotive force BEMF_{β} (middle), and a waveform of a counter electromotive force magnitude Vm (bottom) within the predetermined period. FIG. 21 illustrates a waveform of the number of revolutions (rps) of the motor within the predetermined period, which is estimated by the method of estimating the number of revolutions according to the present disclosure. Horizontal axes in FIGS. 18 to 21 represent time (seconds). Vertical axes in FIGS. 18 and 21 represent the number of revolutions (rps). The vertical axis in FIG. 19 represents the rotor angle (degree). The vertical axis in FIG. 20 represents a voltage (V).

FIGS. 18 to 21 illustrate various waveforms obtained when the rotor is rotating at low speed (−16 rps) in the reverse rotation direction. In FIGS. 18 and 21, absolute values of the number of revolutions of the motor are shown.

The result of FIG. 21 means that the rotation number calculation unit 110 obtained the number of revolutions (−16 rps) of the rotor. Comparing FIGS. 18 and 21, it may be seen that when the rotor is rotating at low speed in the reverse rotation direction, values close to the actual number of revolutions of the rotor may be accurately estimated.

Through the above-described simulation results, it may be seen that according to the method of estimating the number of revolutions of the rotor of the present disclosure, the number of revolutions of the rotor may be accurately estimated over a wide range from the low-speed driving to the high-speed driving including starting time.

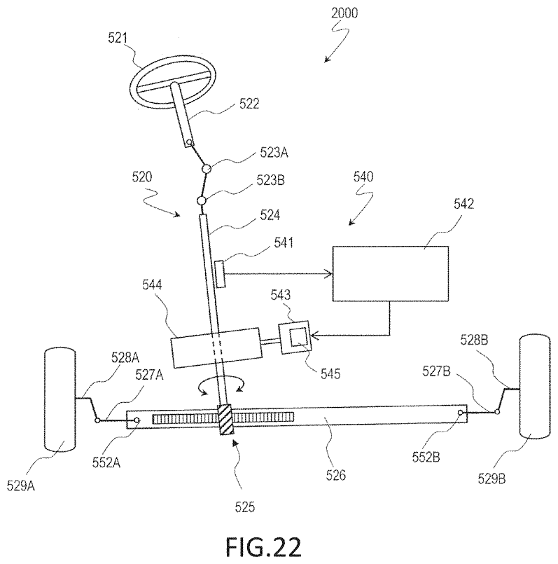

FIG. 22 schematically illustrates a typical configuration of an EPS system 2000 according to the present example embodiment.

Vehicles such as automobiles generally include an EPS system. The EPS system 2000 according to the present example embodiment includes a steering system 520 and an auxiliary torque mechanism 540 generating an auxiliary torque. The EPS system 2000 generates the auxiliary torque that assists a steering torque of the steering system generated by a driver's operation of a steering wheel. The burden on the driver's operation is reduced by the auxiliary torque.

The steering system 520 includes, for example, a steering wheel 521, a steering shaft 522, universal joint couplings 523A and 523B, a rotating shaft 524, a rack and pinion mechanism 525, a rack shaft 526, left and right ball joints 552A and 552B, tie rods 527A and 527B, knuckles 528A and 528B, and left and right steering wheels 529A and 529B.

The auxiliary torque mechanism 540 includes, for example, a steering torque sensor 541, an electronic control unit (ECU) 542 for an automobile, a motor 543, and a reduction mechanism 544. The steering torque sensor 541 detects the steering torque in the steering system 520. The ECU 542 generates a driving signal on the basis of the detected signal by the steering torque sensor 541. The motor 543 generates an auxiliary torque corresponding to the steering torque on the basis of the driving signal. The motor 543 transfers the generated auxiliary torque to the steering system 520 through the reduction mechanism 544.

The ECU 542 includes, for example, the controller 100 and the driving circuit 200 according to the first example embodiment. In automobiles, an electronic control system is constructed using an ECU as a core. In the EPS system 2000, a motor control system is constructed by, for example, the ECU 542, the motor 543, and an inverter 545. As the motor control system, the motor control system 1000 according to the first example embodiment may be suitably used.

Example embodiments of the present disclosure may also be suitably used for motor control systems such as an-x-by wire system including a shift-by-wire system, a steering-by-wire system, a brake-by-wire system, and the like, and a traction motor system, and the like, in which detection capability of the number of revolutions of the rotor is required.

For example, a motor control system according to example embodiments of the present disclosure may be mounted on an automated driving vehicle corresponding to levels 0 to 4 (automation levels) defined by the Government of Japan and the National Highway Traffic Safety Administration (NHTSA) of the U.S. Department of Transportation.

Example embodiments of the present disclosure may be widely used in a variety of devices equipped with various motors, such as cleaners, dryers, ceiling fans, washing machines, refrigerators, and electric power steering systems.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-7. (canceled)

8: A method of controlling a motor, the method comprising:
a step A of obtaining a component BEMF_{α} on an α-axis and a component BEMF_{β} on a β-axis of counter electromotive force of the motor in an αβ fixed coordinate system;
a step B of performing time differentiation on each of the component BEMF_{α} on the α-axis and the component BEMF_{β} on the β-axis;
a step C of squaring a differentiated value of the component BEMF on the α-axis to obtain a first multiplication value and squaring a differentiated value of the component BEMF_{β} on the β-axis to obtain a second multiplication value;
a step D of calculating a square root of a sum of the first multiplication value and the second multiplication value;
a step E of obtaining an absolute value of the counter electromotive force in the αβ fixed coordinate system based on the component BEMF_{α} on the α-axis and the component BEMF_{β} on the β-axis;
a step F of obtaining at least one of a rotational speed and a number of revolutions of a rotor of the motor based on the absolute value of the counter electromotive force and a value of the square root; and
a step G of controlling the motor based on at least one of the rotational speed and the number of revolutions of the rotor.

9: The method of claim 8, wherein in the step A, the component BEMF_{α} on the α-axis is calculated based on Equation (1), and the component BEMF_{β} on the β-axis is calculated based on Equation (2):
BEMF_{α}=V_{α}*−R·I_{α} (1)
BEMF_{β}=V_{β}*−R·I_{β} (2)
wherein V_{α} * represents a reference voltage on the α-axis, V_{β}* represents a reference voltage on the β-axis, I_{α} is a component of an armature current on the α-axis, I_{β} is a component of the armature current on the β-axis, and R represents an armature resistance.

10: The method of claim 8, wherein in the step E, an absolute value BEMF of the counter electromotive force of the motor in the αβ fixed coordinate system is calculated based on Equation (3):
BEMF=(BEMF_{α}²+BEMF_{β}²)^{1/2} (3).

11: The method of claim 8, wherein in the step F, the rotational speed of the rotor is obtained by dividing the value of the square root by the absolute value of the counter electromotive force.

12: The method of claim 11, wherein in the step F, the rotational speed of the rotor is multiplied by about ½π to obtain the number of revolutions.

13: A motor control system comprising:
a motor; and
a control circuit to control the motor and to:
obtain a component BEMF_{α} on an α-axis and a component BEMF_{β} on a β-axis of counter electromotive force of the motor in an αβ fixed coordinate system;
perform time differentiation on each of the component BEMF_{α} on the α-axis and the component BEMF_{β} on the β-axis;
square a differentiated value of the component BEMF_{α} on the α-axis to obtain a first multiplication value and square a differentiated value of the component BEMF_{β} on the β-axis to obtain a second multiplication value;
calculate a square root of a sum of the first multiplication value and the second multiplication value;
obtain an absolute value of the counter electromotive force in the αβ fixed coordinate system based on the component BEMF_{α} on the α-axis and the component BEMF_{β} on the β-axis;
obtain at least one of a rotational speed and a number of revolutions of a rotor of the motor based on the absolute value of the counter electromotive force and a value of the square root; and
control the motor based on at least one of the rotational speed and the number of revolutions of the rotor.

14: An electric power steering system comprising the motor control system of claim 13.
